(19) United States
(12) Patent Application Publication
(10) Pub. No.: US 2015/0279125 A1
(43) Pub. Date: Oct. 1, 2015

(54) VARIABLE REPORTING RATE TELEMATICS

(71) Applicant: Ford Global Technologies, LLC, Dearborn, MI (US)

(72) Inventors: David CHRONOWSKI, Harrison Township, MI (US); Kevin Michael BULLISTER, Dexter, MI (US)

(73) Assignee: Ford Global Technologies, LLC, Dearborn, MI (US)

(21) Appl. No.: 14/224,161

(22) Filed: Mar. 25, 2014

(51) Int. Cl. G07C 5/00

(52) U.S. Cl. CPC G07C 5/008

(57) ABSTRACT

A vehicle controller may collect vehicle data related to functioning of at least one vehicle system according to reporting settings maintained by the controller; send the vehicle data to a server according to a reporting frequency specified by the reporting settings; and update the reporting settings responsive to receipt from the server of a command configured to cause the at least one controller to adjust the reporting settings. A system may include a server configured to receive vehicle data from a vehicle; identify a vehicle-related trigger condition; evaluate the trigger condition according to the received vehicle data; responsive to trigger condition occurrence, generate a command configured to adjust reporting settings used by the vehicle in providing the vehicle data to the server; and send the command to the vehicle.

### TECHNICAL FIELD

The illustrative embodiments generally relate to a method and apparatus for utilizing a variable reporting rate for providing telematics information.

### BACKGROUND

Vehicle telematics units may be utilized to allow a user of a vehicle to interact with services available over a communications network. These services may include turn-by-turn directions, telephone communications, vehicle monitoring, and roadside assistance. In some cases, the telematics services may be provided by the vehicle or telematics unit manufacturer, while in other cases, the services may be provided by a third party telematics service provider.

### SUMMARY

In a first illustrative embodiment, a system includes at least one controller of a vehicle configured to identify an initiating trigger condition for increased vehicle data reporting frequency to a remote telematics service provider; update, responsive to the initiating trigger condition, a telematics reporting frequency from a default rate to a faster rate; identify a terminating trigger condition in which the increased reporting frequency is no longer required; and update the telematics reporting frequency back to the default rate.

In a second illustrative embodiment, a system includes a server configured to receive vehicle data from a vehicle; identify a vehicle-related trigger condition; evaluate the trigger condition according to the received vehicle data; responsive to trigger condition occurrence, generate a command configured to adjust reporting settings used by the vehicle in providing the vehicle data to the server; and send the command to the vehicle.

In a third illustrative embodiment, a system includes a vehicle controller configured to collect vehicle data, related to functioning of a vehicle system, according to reporting settings maintained by the controller; send the vehicle data to a server according to a reporting-setting-specified reporting frequency; and update the reporting settings responsive to receipt from the server of a command configured to cause the controller to adjust the reporting settings.

### BRIEF DESCRIPTION OF THE DRAWINGS

FIG. 1 illustrates an example block topology for a vehicle-based computing system for a vehicle;

FIG. 2 illustrates an exemplary telematics system including a remote telematics service provider in communication via network with the vehicle-based computing system of the vehicle;

FIG. 3 illustrates an exemplary process for providing variable rate telematics update commands to the vehicle-based computing system of the vehicle; and

FIG. 4 illustrates an exemplary process for providing variable rate telematics vehicle data from the vehicle-based computing system to the remote telematics service provider.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle-based computing system (VCS), such as a vehicle telematics unit, may be configured to accumulate vehicle data, in some cases treat the vehicle data via on-board calculations, and periodically offload the accumulated and processed data to a remote telematics service provider. The vehicle data that is offloaded may be further augmented with additional information, such as current vehicle conditions and location. The rate of data offload, as well as the elements of vehicle data to be included, may be designed to balance costs associated with the offload of vehicle data (such as cellular charges and battery power usage) with the benefits of providing increased granularity of the vehicle data.

Under some vehicle operating conditions or applications, it may be desirable to provide greater insight into vehicle operation than during other conditions. As one possibility, it may be useful for an increased frequency of vehicle data to be provided by a police vehicle to a remote telematics service provider during emergency pursuit. As another possibility, it may be useful for an increased frequency of vehicle data to be provided for a vehicle for which a trouble code has been raised. As a further possibility, a vehicle fleet manager may desire additional vehicle information if a vehicle is operated outside of a pre-specified geographical area or time. Returning to the example of a police pursuit, an emergency command center may desire to receive a video stream via the remote telematics service provider from a dash cam of a vehicle while the vehicle is in pursuit.

To allow for additional vehicle data to be provided when needed, and to save resources otherwise, the VCS may be configured to implement variable telematics reporting rate functionality. Based on the vehicle data, the VCS or the remote telematics service provider may be configured to identify the occurrence of one or more trigger conditions. Responsive to the occurrence of the trigger conditions, the VCS or the remote telematics service provider may be configured to cause the VCS to adjust reporting settings used by the vehicle in the providing of vehicle data to the remote telematics service provider. As one possibility, the remote telematics service provider may identify occurrence of the trigger condition, and may adjust the vehicle reporting settings by providing a command from the remote telematics service provider to the vehicle via cellular link. As another possibility, the VCS may identify occurrence of locally stored trigger condition, and may adjust the reporting settings locally.

An initiating trigger condition may include conditions that when satisfied are indicative of vehicle situations for which increased reporting may be desirable. Upon detection of an initiating trigger condition, the VCS may be configured to adjust vehicle data reporting settings to increase a telematics reporting frequency from an original rate to a faster rate, thereby providing an increased reporting frequency to the telematics service provider. As an example, an initiating trigger condition may include conditions that when satisfied are indicative of an emergency pursuit, such as one or more elements of vehicle dynamics data and corresponding values for those element indicative of pursuit (e.g., high g-forces, acceleration, braking, etc.). As another example, an initiating trigger condition may include conditions that when satisfied are indicative of other vehicle situations for which increased reporting may be desirable, such as upon detection of one or more abnormal vehicle operating conditions (e.g., low fuel, a system malfunction, etc.).

A terminating trigger condition may include conditions that when satisfied are indicative of vehicle situations for which increased reporting is no longer desirable. Upon detection of a terminating trigger condition, the VCS may be configured to adjust vehicle data reporting settings to revert back to default settings. The terminating trigger conditions may include, as some examples, a (i) a timeout, (ii) an override command received from a vehicle occupant, (iii) an override command automatically generated by the at least one controller based on predetermined conditions (e.g., vehicle key-off, expiration of a timeout since the initiating trigger condition, reduced speed/braking), and (iv) an override command received from the remote telematics service provider.

In addition to the variations in the reporting rate, the telematics unit may be configured to provide more, less, or different information during increased reporting frequency mode as opposed to default reporting frequency mode. For example, based on certain trigger criteria, the telematics unit may be configured to begin providing a video stream to the remote telematics service provider (e.g., from a dash cam of a vehicle while the vehicle is in pursuit). Accordingly, a telematics unit may utilize variable reporting rate functionality to adjust the frequency and content of data transmission from the telematics unit of the vehicle to the remote telematics service provided, to balance costs associated with cellular offload of vehicle data with the benefits of providing increased granularity of the vehicle data during defined trigger conditions.

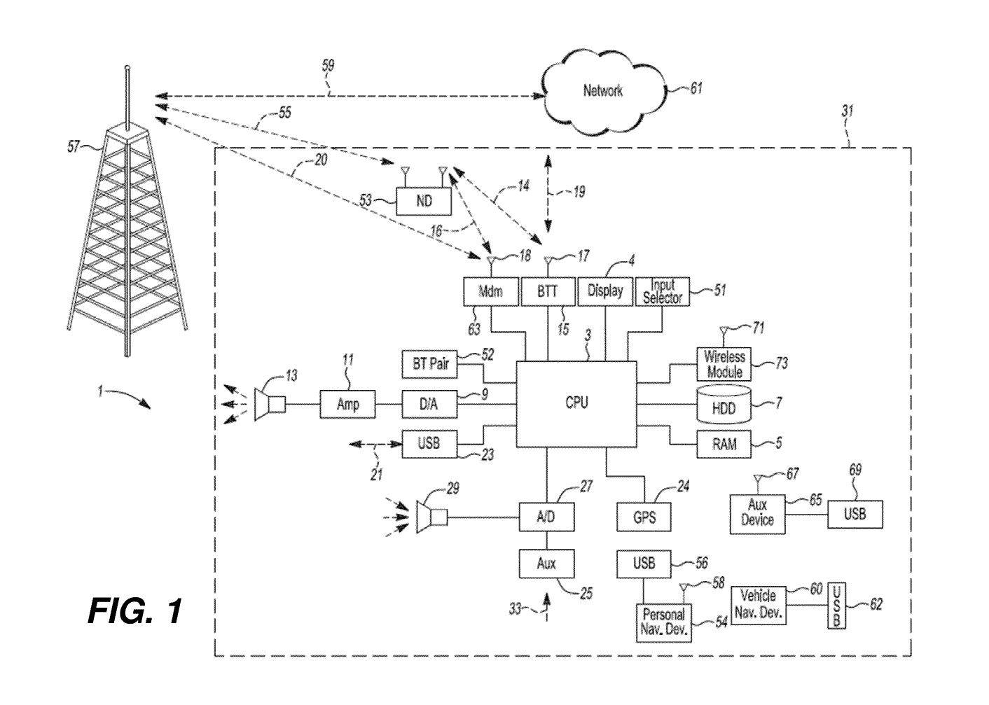

FIG. 1 illustrates an example block topology for a vehicle-based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle 31. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 or central processing unit (CPU) 3 controls at least some portion of the operation of the vehicle-based computing system. Provided within the vehicle 31, the processor 3 allows onboard processing of commands and routines. Further, the processor 3 is connected to both non-persistent 5 and persistent storage 7. In this illustrative embodiment, the non-persistent storage 5 is random access memory (RAM) and the persistent storage 7 is a hard disk drive (HDD) or flash memory. In general, persistent (non-transitory) storage 7 can include all forms of memory that maintain data when a computer or other device is powered down. These include, but are not limited to, HDDs, compact disks (CDs), digital versatile disks (DVDs), magnetic tapes, solid state drives, portable universal serial bus (USB) drives and any other suitable form of persistent storage 7.

The processor 3 is also provided with a number of different inputs allowing the user to interface with the processor 3. In this illustrative embodiment, a microphone 29, an auxiliary input 25 (for input 33), a USB input 23, a global positioning system (GPS) input 24, a screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor 3. Although not shown, numerous of the vehicle components and auxiliary components in communication with the VCS 1 may use a vehicle network (such as, but not limited to, a car area network (CAN) bus) to pass data to and from the VCS 1 (or components thereof).

Outputs to the VCS system 1 can include, but are not limited to, a visual display 4 and a speaker 13 or stereo system output. The speaker 13 is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a nomadic device (ND) 53 (e.g., cell phone, smart phone, PDA, or any other device having wireless remote network connectivity). The nomadic device 53 can then be used to communicate 59 with a network 61 outside the vehicle 31 through, for example, communication 55 with a cellular tower 57. In some embodiments, tower 57 may be a WiFi access point.

Exemplary communication between the nomadic device 53 and the BLUETOOTH transceiver is represented by communication 14.

Pairing a nomadic device 53 and the BLUETOOTH transceiver 15 can be instructed through a button 52 or similar input. Accordingly, the CPU is instructed that the onboard BLUETOOTH transceiver 15 will be paired with a BLUETOOTH transceiver in a nomadic device 53.

Data may be communicated between CPU 3 and network 61 utilizing, for example, a data-plan, data over voice, or dual-tone multiple frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem 63 and communication 20 may be cellular communication.

In one illustrative embodiment, the processor 3 is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the Institute of Electrical and Electronics Engineers (IEEE) 802 personal area network (PAN) protocols. IEEE 802 local area network (LAN) protocols include wireless fidelity (WiFi) and have considerable cross-functionality with IEEE 802 PAN. Both are suitable for wireless communication within a vehicle 31. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device 53 can talk over the device while data is being transferred. At other times, when the owner is not using the device, the data transfer can use the whole bandwidth (300 Hz to 3.4 kHz in one example). While frequency division multiplexing may be common for analog cellular communication between the vehicle 31 and the Internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle 31. 3G standards are now being replaced by IMT-Advanced (4G) which offers 200 mbs for users in a vehicle 31 and 1 gbs for stationary users. If the user has a data-plan associated with the nomadic device 53, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless LAN device capable of communication over, for example (and without limitation), an 802.11g network (i.e., WiFi) or a WiMax network.

In one embodiment, incoming data can be passed through the nomadic device 53 via a data-over-voice or data-plan, through the onboard BLUETOOTH transceiver and into the processor 3 of the vehicle 31. In the case of certain temporary data, for example, the data can be stored on the HDD or other storage media 7 until such time as the data is no longer needed.

Additional sources that may interface with the vehicle 31 include a PND 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 3 could be in communication with a variety of other auxiliary devices 65. These devices 65 can be connected through a wireless 67 or wired 69 connection. Auxiliary device 65 may include, but are not limited to, personal media players, wireless health devices, portable computers, and the like.

Also, or alternatively, the CPU 3 could be connected to a vehicle-based wireless router 73, using for example a WiFi (IEEE 803.11) 71 transceiver. This could allow the CPU 3 to connect to remote networks within range of the local router 73.

In addition to having exemplary processes executed by a vehicle computing system located in a vehicle 31, in certain embodiments, the exemplary processes may be executed at least in part by one or more computing systems external to and in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process includes a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the VCS 1 located within the vehicle 31 itself is capable of performing the exemplary processes.

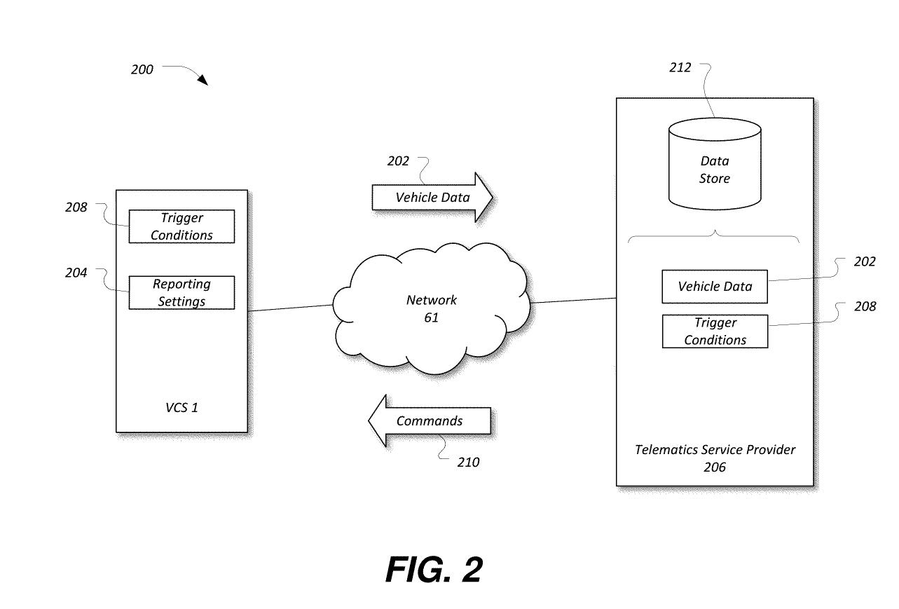

FIG. 2 illustrates an exemplary telematics system 200 including a remote telematics service provider 206 in communication via network 61 with the VCS 1 of the vehicle 31. The VCS 1 may be configured to provide vehicle data 202 over the network 61 to the telematics service provider 206 in accordance with the current reporting settings 204. The telematics service provider 206 may be configured to receive and maintain the vehicle data 202, as well as maintain one or more trigger conditions 208. Based on satisfaction of various trigger conditions 208 maintained by the telematics service provider 206, the VCS 1 may be further configured to receive commands 210 over the network 61 generated by remote telematics service provider 206, where the commands 210 are configured to alter the vehicle reporting settings 204. Additionally or alternately, the VCS 1 may be configured to locally adjust the current reporting settings 204, based on satisfaction of various trigger conditions 208 stored locally by the vehicle 31.

The vehicle data 202 may include various elements of information available over a vehicle bus or network (e.g., the CAN bus) that may be useful for analysis. For example, the vehicle data 202 may include data collected from vehicle systems such as vehicle stability, traction control, power train, and driver assistance. Exemplary vehicle data 202 may accordingly include values retrieved from vehicle systems, such as vehicle velocity, steering wheel angle, heave displacement, heave velocity, yaw rates, lateral acceleration, pitch angle, pitch rate, vehicle slip angle, roll angle, roll rate, slip/spin wheel conditions, driver torque applied drive wheel torque, applied wheel brake pressure, fuel remaining, and engagement of emergency flashers or sirens, as some non-limiting examples. The vehicle data 202 may also include other types of information regarding the vehicle 31, such as vehicle geographic location (e.g., from an on-board global positioning system), date and time information during which the vehicle data 202 may have been collected, and information identifying the sending vehicle 31 such as vehicle identification number (VIN), international mobile station equipment identity (IMEI) of the VCS 1, or another vehicle-specific identifier.

The reporting settings 204 may include information indicative of how often the vehicle data 202 should be collected, as well as what information should be included in the collected vehicle data 202. As one possibility, the reporting settings 204 may include a frequency setting indicative of an update rate or period between providing vehicle data 202 updates to the telematics service provider 206. For instance, the reporting settings 204 may include a default reporting rate indicative of how often to provide the vehicle data 202 to the telematics service provider 206 when no trigger conditions 208 have occurred, and a faster reporting rate indicative of how often to provide the vehicle data 202 to the telematics service provider 206 when one or more trigger conditions 208 have occurred. The default or normal rate may be, for example, every thirty seconds, every minute, every three minutes, or every five minutes, as some non-limiting possibilities. The faster rate may be, for example, every three seconds, every five seconds, every thirty seconds, or some other rate that is includes more frequent updates than the default or normal reporting rate. In some cases, the faster rate may be defined as a multiple of the default rate, such as twice as fast or five times as fast as the default rate.

The reporting settings 204 may further include a listing of vehicle data 202 values to be included in the periodic updates. In some cases, the reporting settings 204 may include multiple sets of settings, such as a first set of vehicle data 202 to be provided every first period of time, and a second set of vehicle data 202 to be provided every second period of time. As another possibility, the reporting settings 204 may include a set of vehicle data 202 to be provided at the default rate regardless of mode, and a second set of vehicle data 202 to be provided at the faster rate when a trigger condition 208 has been satisfied.

The telematics service provider 206 may include one or more computing devices, such as computers, a microprocessor-based appliances, a peer networked devices or network nodes. The telematics service provider 206 may be configured to execute programs on one or more processors, where the programs are stored on one or more memory devices of the telematics service provider 206. The telematics service provider 206 may further include network hardware configured to allow the telematics service provider 206 to communicate with the vehicles 31 over the network 61. As one example, the telematics service provider 206 may be configured to receive the vehicle data 202 from the vehicles 31 via the network 61. While the network 61 is illustrated as being a single network 61, in some examples the network 61 may be implemented as multiple separate networks 61, such as a private network 61 housing the telematics server provider 206 connected to a public network such as the Internet for data transport between the telematics service provider 206 and the vehicles 31.

The trigger conditions 208 may include information indicative of conditions that, when satisfied by the vehicle data 202, cause an alteration in the reporting settings 204 of the vehicle 31. The trigger conditions 208 may further include information indicative of how the reporting settings 204 should be modified based on satisfaction of the conditions. The telematics service provider 206 may be configured to maintain the trigger conditions 208, evaluate the received vehicle data 202 (or other acquired data regarding the vehicles 31) against the trigger conditions 208, and provide commands 210 to the vehicle 31 to cause the vehicle 31 to update its reporting settings 204 as specified by the trigger conditions 208.

For instance, the trigger conditions 208 may include initiating trigger conditions 208 configured to alter the reporting settings 204 based on occurrence of a situation in which more frequent or more complete reporting of vehicle data 202 is desired. As one possibility, the trigger conditions 208 may include vehicle data 202 exceeding one or more vehicle dynamic thresholds indicating vehicle pursuit (e.g., high g-forces, acceleration, braking, etc.). As another possibility, the trigger conditions 208 may include vehicle data 202 being indicative of one or abnormal vehicle operating conditions (e.g., low fuel, system malfunction, etc.).

Moreover, the trigger conditions 208 may also include terminating trigger conditions 208 in which the increased reporting settings 204 are no longer required. As one possibility, the terminating trigger conditions may include a predetermined about of time having passed since the initiating trigger conditions were met (e.g., a predetermined timeout). As some other possibilities, terminating trigger conditions may include an override command provided by an occupant of the vehicle 31 or from the telematics service provider 206, or satisfaction of one or more conditions, such as vehicle key-off, reduced vehicle 31 speeds, or relaxed vehicle 31 braking.

The commands 210 may include information that, when received by the vehicle 31, may cause the vehicle 31 to alter its reporting settings 204. For example, a command 210 may include updated reporting settings 204 that should be used by the vehicle 31 (e.g., an updated reporting frequency, an updated set of vehicle data 202 elements to be provided, etc.). As another possibility, the command 210 may specify an indication of which set of reporting settings 204 maintained by the vehicle 31 should be used by the vehicle 31 (e.g., normal reporting mode, faster reporting mode, etc.).

The data store 212 may include one or more storage devices configured to maintain information for the telematics service provider 206. For example, the data store 212 may maintain the vehicle data 202 received from the vehicles 31 used to process the trigger conditions 208, and the trigger conditions 208 used to generate the commands 210. The data store 212 may store additional information as well, such as which trigger conditions 208 are associated with what vehicles 31 (e.g., according to vehicle identifier), which vehicles are associated with which fleets (e.g., mapping vehicle identifiers to fleet identifiers) and which trigger conditions 208 are associated with which fleets (e.g., according to fleet identifier). Accordingly, the data store 212 may be used to store trigger conditions 208 that are associated with vehicles 31 in general, trigger conditions 208 that are associated with vehicles 31 that are a part of a fleet, and/or trigger conditions 208 that are associated with specific vehicles 31.

The data store 212 may be configured to be queried by vehicle identifier, and may provide any trigger conditions 208 that match to the specified vehicle 31 or to vehicles 31 generally. Thus, the retrieves trigger conditions 208 may include any of general trigger conditions 208, fleet trigger conditions 208, and vehicle-specific trigger conditions 208. In some cases, the trigger conditions 208 may form a hierarchy, such that inconsistent trigger conditions 208 may be overridden by other trigger conditions 208 having priority. For example, the fleet trigger conditions 208 or vehicle-specific trigger conditions 208 may override the general trigger conditions 208, and the vehicle-specific trigger conditions 208 may override fleet trigger conditions 208 (or the reverse).

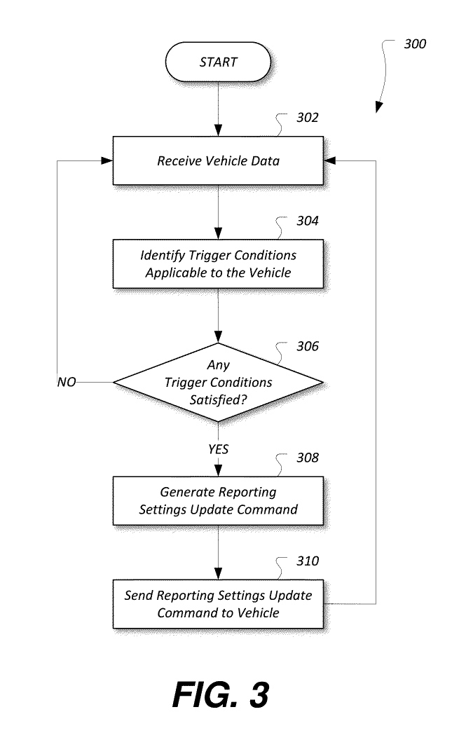

FIG. 3 illustrates an exemplary process 300 for providing variable rate telematics update commands 210 to the VCS 1 of the vehicle 31. The process 300 may be performed, for example, by the telematics service provider 206 in communication with the VCS 1 of the vehicle 31 over the network 61. In other embodiments, the process 300 may be implemented in other controllers, or distributed amongst multiple controllers.

At block 302, the telematics service provider 206 receives vehicle data 202 from the vehicle 31. For example, the telematics service provider 206 may receive a periodic vehicle data 202 update, sent from the vehicle 31 according to reporting settings 204 of the vehicle 31. The vehicle data 202 may include information from vehicle systems as discussed above, as well as other information, such as vehicle geographic location, date and time information during which the vehicle data 202 was collected, and information identifying the sending vehicle 31.

At block 304, the telematics service provider 206 identifies trigger conditions 208 applicable to the vehicle 31. For example, the telematics service provider 206 may query the data store 212 using the information from the vehicle data 202 identifying the vehicle 31 to retrieve any trigger conditions 208 associated with the vehicle 31. Additionally or alternately, the telematics service provider 206 may query the data store 212 to identify a fleet associated with the vehicle 31, and may retrieve any trigger conditions 208 associated with the fleet with which the vehicle 31 is associated. As yet a further example, the telematics service provider 206 may retrieve any trigger conditions 208 generally applicable to all vehicles 31.

At decision block 306, the telematics service provider 206 determines, based on the received vehicle data 202 and applicable trigger conditions 208, whether any of the applicable trigger conditions 208 are satisfied or have expired. For example, the telematics service provider 206 may evaluate the identified trigger conditions 208 based on the retrieved vehicle data 202. The trigger conditions 208 may include, as some possibilities, identification that the vehicle 31 has entered or left a predetermined geographical area, and/or that the vehicle 31 is being operated during a predetermined time frame. As another example, the telematics service provider 206 may further evaluate whether expiration of any previously triggered trigger conditions 208 has occurred. Expired trigger conditions 208 may include, as some possibilities, a timeout after which updated reporting settings 204 revert to default reporting settings 204. If any trigger conditions 208 are met or have expired, control passes to block 308. Otherwise, control passes to block 302.

At block 308, the telematics service provider 206 generates reporting settings 204 update commands 210. For example, the telematics service provider 206 may create one or more commands 210 to be provided to the vehicle 31, where the commands 210 include any adjustments to the reporting settings 204 to be performed as specified by the trigger conditions 208 that are met or expired. The command(s) 210 may include updated reporting settings 204 that should be used by the vehicle 31. As another possibility, the command(s) 210 may specify an indication of which set of reporting settings 204 maintained by the vehicle 31 should be used by the vehicle 31 (e.g., normal reporting mode, faster reporting mode, etc.).

At block 310, the telematics service provider 206 sends the reporting settings 204 update command(s) 210 to the vehicle 31. After block 310, control passes to block 302.

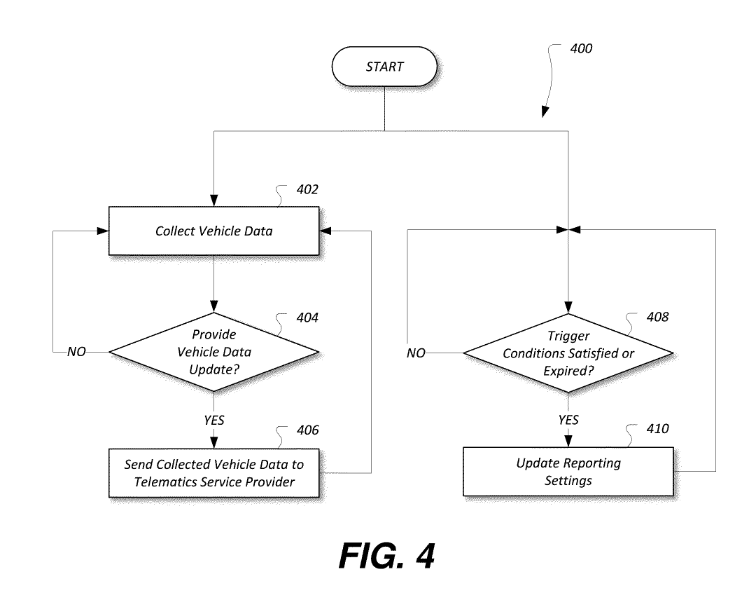

FIG. 4 illustrates an exemplary process 400 for providing variable rate telematics vehicle data 202 from the VCS 1 to the remote telematics service provider 206. The process 400 may be performed, for example, by the VCS 1 of the vehicle 31 in communication with telematics service provider 206. In other embodiments, the process 400 may be implemented in other controllers, or distributed amongst multiple controllers.

At block 402, the VCS 1 collects vehicle data 202. For example, the VCS 1 may collect vehicle data 202 from vehicle systems over a vehicle bus, such as vehicle stability, traction control, power train, and driver assistance information. The vehicle data 202 may also include other types of information regarding the vehicle 31, such as vehicle geographic location (e.g., from an on-board global positioning system), date and time information during which the vehicle data 202 was collected, and information identifying the vehicle 31 such as a VIN or an IMEI. In some cases, the reporting settings 204 may include a listing of vehicle data 202 values to be included in the periodic updates, and the VCS 1 may determine which elements of vehicle data 202 to collect according to the reporting settings 204.

At decision block 404, the VCS 1 determines whether to provide the vehicle data 202 to the telematics service provider 206. For example, the reporting settings 204 may include a frequency setting indicative of a period between providing vehicle data 202 updates to the telematics service provider 206. Based on the frequency settings, the VCS 1 may determine whether a timeout has expired such that updated vehicle data 202 should be provided to the telematics service provider 206. If so, control passes to block 306 to perform the next vehicle data 202 update. Otherwise, control passes to block 302 to continue collecting vehicle data 202.

At block 406, the VCS 1 sends the collected vehicle data 202 to the telematics service provider 206. For example, the VCS 1 may provide the collected vehicle data 202 in one or more messages to the telematics service provider 206. After block 406, control passes to block 402.

At decision block 408, the VCS 1 determines whether any trigger conditions 208 maintained by the vehicle 31 have been satisfied or have expired. For example, the VCS 1 may evaluate the maintained trigger conditions 208 according to the collected vehicle data 202. The evaluation of the trigger conditions 208 maintained by the vehicle 31 may be performed independent of the providing of vehicle data 202 updates to the telematics service provider 206. The trigger conditions 208 may include, as some non-limiting specific examples, that vehicle dynamics data retrieved from the vehicle systems is indicative of a pursuit being performed by the vehicle 31, and/or abnormal vehicle 31 conditions, such as low fuel or an indication of a vehicle 31 malfunction. Expiration of the trigger conditions 208 may include, as some possibilities, a timeout after which updated reporting settings 204 revert to default reporting settings 204, and/or an override command provided to the vehicle 31 from the telematics service provider 206 (e.g., from a fleet manager) revoking the updated reporting settings 204. If any trigger conditions 208 are met or have expired, control passes to block 410. Otherwise, control remains at decision block 408.

At block 410, the VCS 1 updates the reporting settings 204. For example, the VCS 1 may perform any adjustments to the reporting settings 204 specified by the trigger conditions 208 that are met or expired. After block 410, control passes to decision block 408.

Thus, the VCS 1 of the vehicle 31 may utilize trigger conditions 208 to implement variable reporting rate functionality to adjust the frequency and content of vehicle data 202 transmission, to balance costs associated with cellular offload of the vehicle data 202 with the benefits of providing increased granularity of the vehicle data 202 during certain conditions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
at least one controller of a vehicle configured to
identify an initiating trigger condition for increased vehicle data reporting frequency to a remote telematics service provider;
update, responsive to the initiating trigger condition, a telematics reporting frequency from a default rate to a faster rate;
identify a terminating trigger condition in which the increased reporting frequency is no longer required; and
update the telematics reporting frequency back to the default rate.

2. The system of claim 1, wherein the initiating trigger condition includes receipt of a command from the remote telematics service provider via cellular link.

3. The system of claim 2, wherein the remote telematics service provider provides the command responsive to receipt of information from the at least one controller indicative of at least one of: (i) the vehicle having entering a predetermined geographical area, (ii) the vehicle having left a predetermined geographical area, and (iii) the vehicle being operated within a predetermined time frame.

4. The system of claim 1, wherein the initiating trigger condition includes identification of at least one of: (i) vehicle dynamics data indicating pursuit and (ii) abnormal vehicle operating conditions.

5. The system of claim 1, wherein the terminating trigger condition includes identification of at least one of: (i) an override command received from a vehicle occupant, (ii) an override command generated by the at least one controller based on predetermined conditions, and (iii) an override command received from the remote telematics service provider.

6. The system of claim 5, wherein the predetermined conditions include at least one of: (i) vehicle key-off and (ii) expiration of a timeout since the initiating trigger condition.

7. The system of claim 1, wherein the default rate is on the order of minutes between updates, and the faster rate is on the order of seconds between updates.

8. A system comprising:
a server configured to
receive vehicle data from a vehicle;
identify a vehicle-related trigger condition;
evaluate the trigger condition according to the received vehicle data;
responsive to trigger condition occurrence, generate a command configured to adjust reporting settings used by the vehicle in providing the vehicle data to the server; and
send the command to the vehicle.

9. The system of claim 8, wherein the vehicle data includes a vehicle identifier, and the server is further configured to at least one of:
query a data store of the server for trigger conditions associated with the vehicle identifier; and
query the data store for trigger conditions associated with a fleet identifier associated with the vehicle identifier.

10. The system of claim 8, wherein the command is configured to increase a reporting rate of the vehicle data received from the vehicle.

11. The system of claim 8, wherein the server is further configured to:
responsive to expiration of occurrence of the trigger condition, generate a second command configured to adjust reporting settings used by the vehicle in providing the vehicle data to the server; and
send the second command to the vehicle.

12. The system of claim 11, wherein the command is configured to increase a reporting rate of the vehicle data received from the vehicle from a default rate to a faster rate, and the second command is configured to revert the reporting rate of the vehicle data to the default rate.

13. The system of claim 11, wherein the server is further configured to provides the command responsive to the vehicle data triggering a trigger condition indicative of at least one of (i) the vehicle having entering a predetermined geographical area, (ii) the vehicle having left a predetermined geographical area, (iii) the vehicle being operated within a predetermined time frame, (iv) vehicle dynamics data indicative of pursuit of another vehicle, and (v) abnormal vehicle operating conditions.

14. A system comprising:
a vehicle controller configured to
collect vehicle data, related to functioning of a vehicle system, according to reporting settings maintained by the controller;
send the vehicle data to a server according to a reporting-setting-specified reporting frequency; and
update the reporting settings responsive to receipt from the server of a command configured to cause the controller to adjust the reporting settings.

15. The system of claim 14, wherein the vehicle controller is further configured to update the reporting frequency according to the command.

16. The system of claim 14, wherein the vehicle controller is further configured to update the reporting settings to send an additional item of vehicle data to the server.

17. The system of claim 16, wherein the additional item of vehicle data is a video stream captured by the vehicle.

18. The system of claim 14, wherein the vehicle controller is further configured to revert the reporting settings to default settings responsive to an override command received by the vehicle controller from a vehicle occupant.
